(19) United States
(12) Patent Application Publication
(10) Pub. No.: US 2010/0171823 A1
(43) Pub. Date: Jul. 8, 2010

(54) ALIGNMENT APPARATUS FOR SEMICONDUCTOR WAFER

(76) Inventors: Masayuki Yamamoto, Osaka (JP); Satoshi Ikeda, Kameyama-shi (JP)

Correspondence Address: Cheng Law Group, PLLC, 1100 17th Street, N.W., Suite 503, Washington, DC, 20036, US

(21) Appl. No.: 12/649,120

(22) Filed: Dec. 29, 2009

(30) Foreign Application Priority Data
Jan. 8, 2009 (JP) 2009-002312

(51) Int. Cl. H04N 7/18; G01B 11/26

(52) U.S. Cl. 348/95; 356/138

(57) ABSTRACT

A wafer has an annular ridge formed along an outer periphery thereof to serve as a reinforcing portion, and a circuit pattern surrounded with the reinforcing portion. The wafer is placed on a wafer placement plane of a holding stage in a state that the circuit pattern is directed downward. The wafer placement plane is larger in size than the wafer. On the holding stage, a center of the wafer is aligned with a center of the holding stage in such a manner that a plurality of guide pins are engaged with relevant cutout portions formed on the reinforcing portion. Then, the holding stage rotates while suction-holding the reinforcing portion of the wafer, and simultaneously a photosensor detects a portion for alignment formed on the outer periphery of the wafer.

### BACKGROUND OF THE INVENTION

1. Field of the Invention

The present invention relates to an alignment apparatus that performs alignment on a semiconductor wafer, based on a portion for alignment (an alignment mark), such as a notch, formed on the semiconductor wafer.

2. Description of the Related Art

As disclosed in Japanese Patent No. 3,820,278, for example, a conventional alignment apparatus that performs alignment on a semiconductor wafer (hereinafter, simply referred to as a “wafer”) has the following configuration. That is, an optical sensor measures a position of a peripheral edge of a wafer placed on and suction-held by a holding stage to detect a position of a center of the wafer and a phase position of a portion for alignment, such as a notch or an orientation mark, formed on an outer periphery of the wafer. Based on the detected positions, a control section determines a deviation of the position of the center of the wafer relative to a position of a center of the holding stage in an X-axis coordinate direction, and a deviation of the position of the center of the wafer relative to the position of the center of the holding stage in a Y-axis coordinate direction. Based on the determined deviations, moreover, the control section controls movement of the holding stage in the X-axis coordinate direction and the Y-axis coordinate direction. Further, the control section controls rotation of the holding stage such that the portion for alignment such as the notch is located on a reference phase position which is set in advance.

In order to meet requirements regarding high-density packaging, a wafer tends to have a thin thickness in a range from 100 μm to 50 μm. Moreover, such a wafer tends to be further thinned. Hence, the wafer is considerably reduced in strength. In order to provide rigidity to the thinned wafer, the wafer is subjected to grinding except its outer periphery, so that the outer periphery serves as a reinforcing portion in a form of an annular ridge. In the wafer, a circuit pattern is formed on the ground portion, i.e., a flat recess surrounded with the reinforcing portion.

In the wafer having the outer periphery serving as the reinforcing portion, the rigidity is provided and the circuit pattern is formed on the flat recess. Accordingly, the circuit pattern is effectively protected without use of a tape for surface protection to be joined thereto.

However, the wafer is transferred by a transporting mechanism having a suction pad in such a manner that the suction pad suction-holds the wafer. For this reason, the suction pad suction-holds an entirely flat back face of the wafer, which is directed downward, from above. Therefore, when the wafer is transferred to an alignment stage, a suction pad, which moves upward/downward, at a center of the alignment stage directly suction-holds the circuit pattern of the wafer.

Consequently, there arises a problem that the circuit pattern is damaged from the contact with the suction pad.

### SUMMARY OF THE INVENTION

The present invention is directed to accurately perform alignment on a semiconductor wafer without causing any damage to a circuit pattern formed on the semiconductor wafer.

Additional features of the present invention will be set forth in the description which follows, and in part will be apparent from the description, or may be learned by practice of the invention.

The present invention discloses an alignment apparatus for a semiconductor wafer including an annular ridge serving as a reinforcing portion, the annular ridge being formed on an outer periphery thereof, a flat recess having a circuit pattern formed thereon, the flat recess being surrounded with the reinforcing portion, and a cutout portion for alignment formed on the reinforcing portion.

This alignment apparatus includes: a rotatable holding stage that includes a wafer placement plane which is larger in size than the semiconductor wafer; an optical sensor that detects the portion for alignment formed on the outer periphery of the semiconductor wafer placed on the holding stage in a state that the side on which the circuit pattern is formed is directed downward; a driving mechanism that turns the holding stage; and a control section that performs alignment on the semiconductor wafer, based on the result of detection by the optical sensor.

According to this alignment apparatus, the holding stage is larger in size than the semiconductor wafer. Therefore, when the holding stage holds the semiconductor wafer in the state that the circuit pattern is directed downward, only the annular ridge serving as the reinforcing portion comes into contact with the holding stage. Thus, this configuration allows prevention of direct contact of the circuit pattern with the holding stage, and therefore causes no damage to the circuit pattern.

Moreover, in accordance with the rotation of the holding stage that holds the semiconductor wafer in the state that only the reinforcing portion comes into contact with the holding stage, the optical sensor monitors the outer periphery of the semiconductor wafer. The optical sensor detects a position of a peripheral edge of the semiconductor wafer in order to determine a position of a center of the semiconductor wafer, based on a predetermined arithmetic operation.

Further, the driving mechanism turns the holding stage, based on the result of detection of the portion for alignment, such as a notch, formed on the outer periphery of the semiconductor wafer. By the rotation of the holding stage, the position of the portion for alignment can be corrected to a preset reference phase position.

In the alignment apparatus described above, the holding stage has an outer placement area on which at least the portion for alignment formed on the reinforcing portion lies, the outer placement area being made of a transparent material, and the optical sensor includes a projector and a photodetector opposed to each other with the transparent area of the holding stage interposed therebetween.

According to this configuration, in the state that the holding stage holds only the reinforcing portion of the semiconductor wafer, the optical sensor including the projector and the photodetector can accurately detect the position of the peripheral edge of the semiconductor wafer through the transparent area of the holding stage.

Preferably, the alignment apparatus further includes a guide member that presses the semiconductor wafer placed on the holding stage in a circumferential direction, and aligns the center of the semiconductor wafer with a center of the holding stage.

Preferably, the guide member is a short column guide pin provided upright.

Preferably, the guide pin has a curved surface coming into contact with the semiconductor wafer, the curved surface being formed in accordance with a curvature of the semiconductor wafer.

The center of the semiconductor wafer placed on the holding stage is not necessarily aligned with the center of the holding stage. Further, the phase position of the portion for alignment, such as the notch, formed on the outer periphery of the semiconductor wafer is not fixed.

According to the configuration described above, however, the respective guide members move toward the center of the holding stage to correct the position of the semiconductor wafer by pressing the outer periphery of the semiconductor wafer. In other words, the guide member performs centering on the semiconductor wafer.

In this centering, the guide member directly comes into contact with the peripheral edge of the semiconductor wafer. However, the thick and annular reinforcing portion is formed on the outer periphery of the semiconductor wafer; therefore, there is no possibility that the semiconductor wafer is damaged because of the contact with the guide member. Thus, the semiconductor wafer can smoothly slide on the holding stage. Moreover, the centering is not necessarily performed based on an arithmetic operation; therefore, the semiconductor wafer can be subjected to the centering in a short time. Thus, this configuration shortens a processing cycle, i.e., contributes to improvement in processing efficiency in a case where a large number of semiconductor wafers are subjected to processing successively.

Preferably, the alignment apparatus further includes a horizontal driving mechanism that allows the holding stage to horizontally move on a horizontal plane in a longitudinal direction and a lateral direction. Herein, the control section performs the alignment on the semiconductor wafer, based on information about an image captured by the optical sensor serving as a CCD camera.

According to this configuration, when the holding stage rotates, the CCD camera scans the peripheral edge of the semiconductor wafer to detect the phase position of the notch. The result of detection may be used as information for correcting the direction of the semiconductor wafer.

It is to be understood that both the foregoing general description and the following detailed description are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this specification, illustrate embodiments of the invention, and together with the description serve to explain the principles of the invention.

FIG. 1 shows a cutaway front view of an alignment apparatus.

FIG. 2 shows an enlarged longitudinal section view of main components of a holding stage.

FIG. 3 shows a plan view of the holding stage.

FIGS. 4 to 6 each show a front view of a process of performing alignment.

FIG. 7 shows a cutaway perspective view of a semiconductor wafer to be subjected to processing.

FIG. 8 shows a perspective view of a back side of the semiconductor wafer.

FIG. 9 shows a flowchart of a procedure for performing alignment.

FIG. 10 shows a block diagram of the alignment apparatus.

### DESCRIPTION OF THE PREFERRED EMBODIMENTS

The present invention is described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

One exemplary embodiment of the present invention will be described in detail with reference to the drawings.

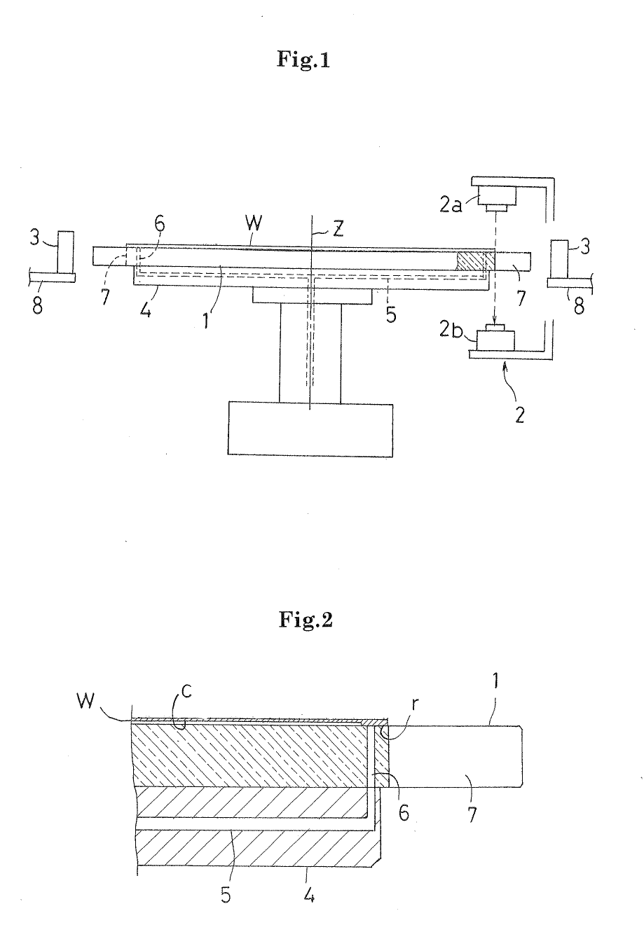

FIG. 1 shows a front view of an alignment apparatus according to the present invention, and FIG. 2 shows a plan view of the alignment apparatus.

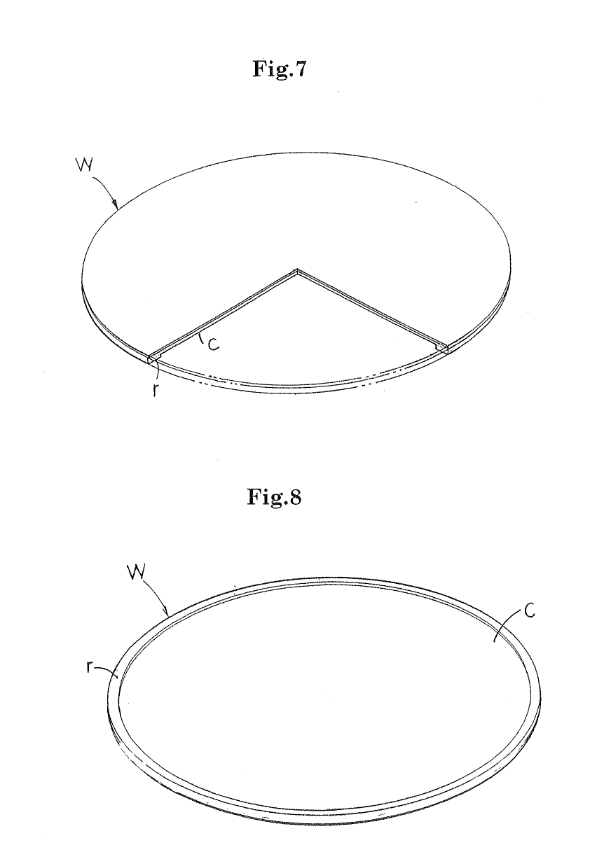

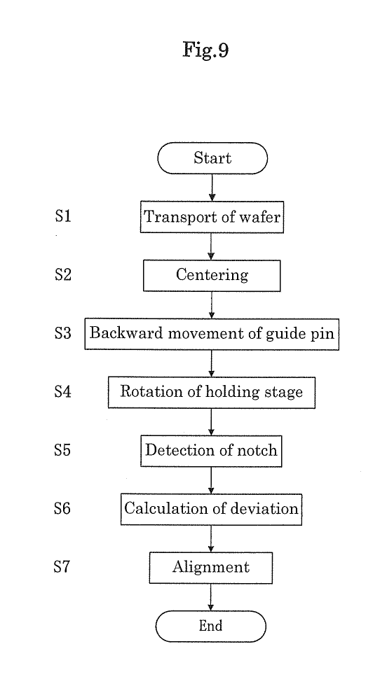

As shown in FIGS. 7 and 8, a semiconductor wafer (hereinafter, simply referred to as a “wafer”) W to be subjected to processing in the alignment apparatus has a configuration that a back face thereof is ground except an outer periphery. That is, the wafer W has a thick and annular reinforcing portion r formed along the outer periphery on the back face. Moreover, a circuit pattern is formed on a flat recess c surrounded with the annular reinforcing portion r. The wafer W is transferred from and to the alignment apparatus in such a manner that a suction pad for transport suction-holds the wafer W from above. Herein, the back face of the wafer W, i.e., the surface on which the circuit pattern is formed is directed downward whereas the reverse surface which is entirely flat is directed upward.

As shown in FIG. 1, the alignment apparatus includes a holding stage 1 that suction-holds the wafer W placed thereon, a photosensor 2 that detects a phase position of a notch n formed as a portion for alignment on the outer periphery of the wafer W, and four guide pins 3 that serve as guide members for performing centering on the wafer W.

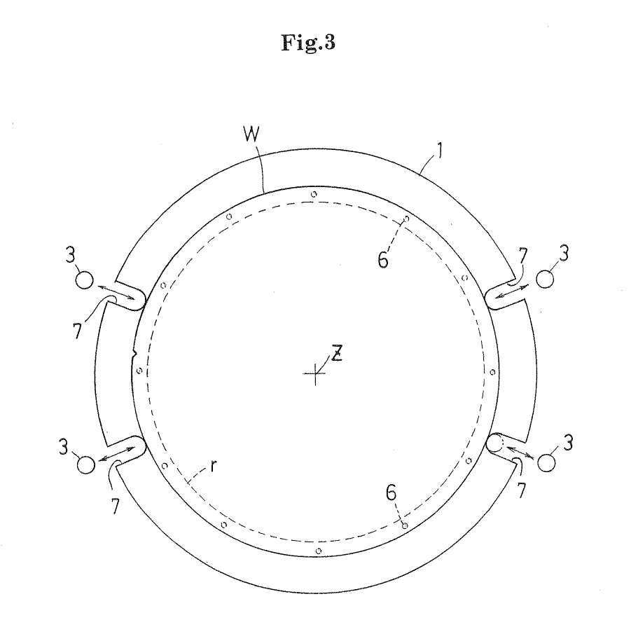

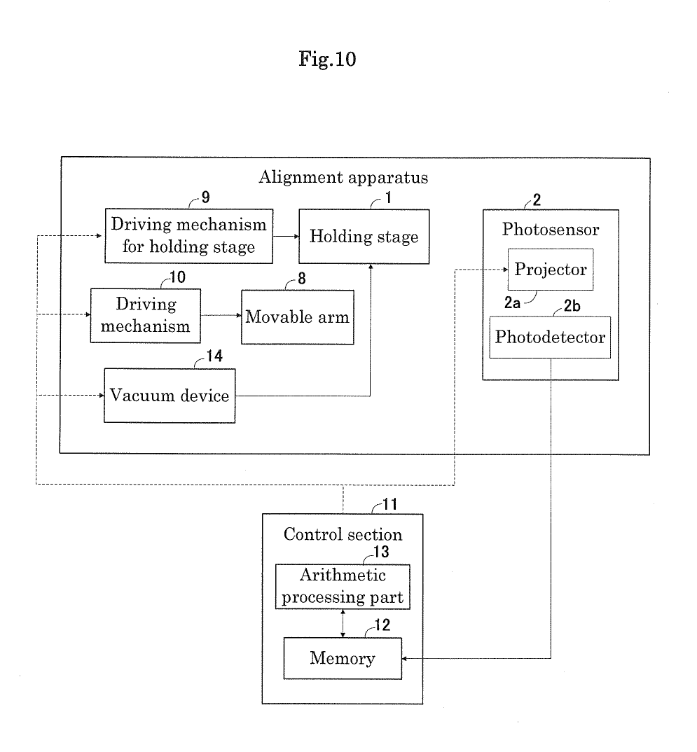

As shown in FIGS. 1 to 3, the holding stage 1 is made of a solid and transparent material such as glass or resin, e.g., polycarbonate. Moreover, the holding stage 1 has a disc shape and is larger in diameter than the wafer W. Further, the holding stage 1 is concentrically attached to a base 4 made of metal through a driving mechanism 9 shown in FIG. 10. Herein, the driving mechanism 9 turns the base 4 about a vertical axis Z passing a center of the holding stage 1.

The base 4 has a channel 5 for suction formed therein, and this channel 5 communicates with a vacuum device 14 shown in FIG. 10. Moreover, the channel 5 is connected to a plurality of suction holes 6 formed near an outer periphery of the holding stage 1. The suction hole 6 is formed to be opposed to the annular reinforcing portion r of the wafer W placed on the holding stage 1 in a state that the center of the wafer W is aligned with the center of the holding stage 1.

The base 4 has a disc shape and is smaller in radius than the wafer W. Herein, the radius of base 4 corresponds to a length obtained by subtracting a length of the notch n from the actual radius of the wafer W. In the state that the center of the wafer W placed on the holding stage 1 is aligned with the center of the holding stage 1, the notch n of the wafer W is located outside the base 4.

The holding stage 1 has four cutout portions 7 formed on the outer periphery thereof in a point symmetry manner relative to the center thereof (the vertical axis X). Each cutout portion 7 permits forward and backward movement of the guide pin 3 and extends toward the center of the holding stage 1. The cutout portion 7 has a length which is set such that an outer peripheral edge of the wafer W contacts therewith in the state that the center of the wafer W is aligned with the center of the holding stage 1.

The guide pin 3 has a short column shape and is provided upright at a tip end of a movable arm 8 so as to protrude vertically from the holding stage 1. The movable arm 8 horizontally and linearly reciprocates through a driving mechanism 10 shown in FIG. 10. By this movement, each guide pin 3 is engaged with and disengaged from the relevant cutout portion 7.

The photosensor 2 is of a transparent type and includes a projector 2a and a photodetector 2b which are opposed to each other with the holding stage 1 interposed therebetween. The outer periphery of the wafer W placed on the holding stage 1 is located on a light emitting area of the photosensor 2. It is to be noted that the photosensor 2 corresponds to an optical sensor according to the present invention.

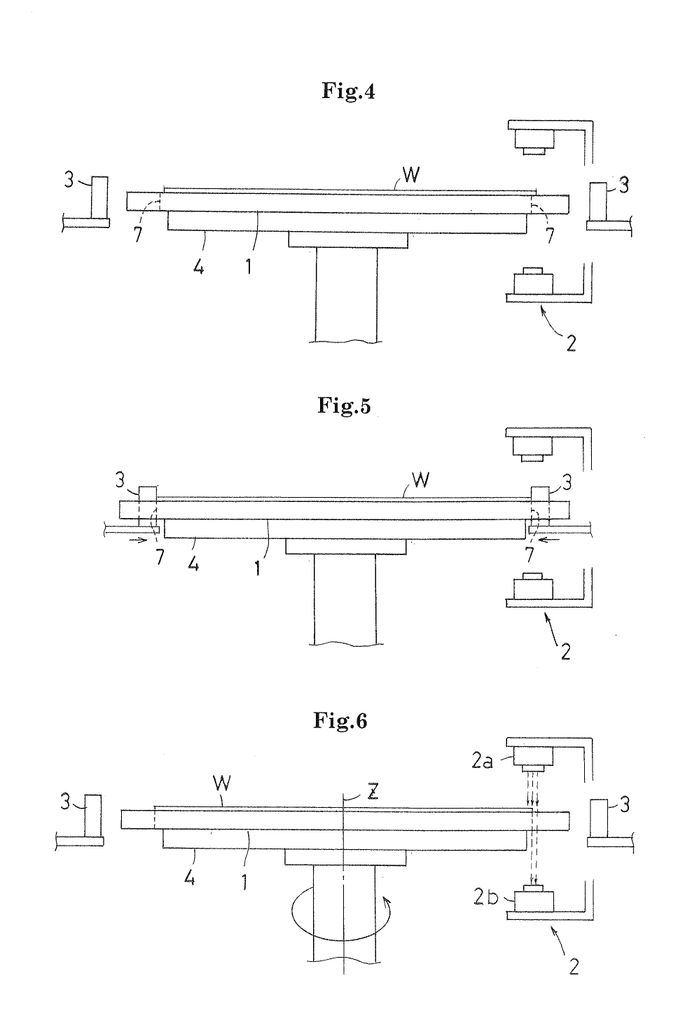

With reference to FIGS. 4 to 6 and a flowchart of FIG. 7, next, description will be made of a procedure for performing alignment on the wafer W in the alignment apparatus described above.

In step S1, first, the suction pad for transport suction-holds the back surface of the wafer W, which is directed upward, from above, and then transfers the wafer W to the holding stage 1 as shown in FIG. 4. Herein, the center of the wafer W is not necessarily aligned with the center of the holding stage 1. Further, the phase position of the notch n on the outer periphery of the wafer W is not fixed.

In step S2, next, each guide pin 3 moves toward the relevant cutout portion 7 and abuts against the cutout portion 7 as shown in FIG. 5. In this state, the center of the wafer W is aligned with the center of the holding stage 1. Further, a negative pressure is applied to the suction hole 6. The holding stage 1 holds the wafer W in such a manner that the annular reinforcing portion r of the wafer W is sucked by the suction hole 6.

In step S3, when the aligned wafer W is suction-held by the holding stage 1, each guide pin 3 moves away from the relevant cutout portion 7.

In step S4, next, the holding stage 1 is rotated one turn in a predetermined direction as shown in FIG. 6.

When the holding stage 1 is rotated, the projector 2a emits a light beam for detection toward the outer periphery of the wafer W, and the photodetector 2b receives the light transmitting through the holding stage 1. In step S5, the photosensor 2 detects the phase position of the notch n on the outer periphery of the wafer W. A memory 12 of a control section 11 stores information about the detected phase position.

In step S6, next, an arithmetic processing part 13 of the control section 11 reads the information about the detected notch n and a preset reference phase position from the memory 12, compares the phase position with the reference phase position, and determines a deviation of the notch n from the result of comparison while converting the obtained deviation into an angle.

In step S7, next, the control section 11 controls the rotation of the holding stage 1, based on the determined deviation, to correct the phase position of the notch n to the reference phase position.

Thus, the alignment process is completed. Then, the suction pad for transport transfers the wafer W subjected to the alignment from the holding stage 1 while suction-holding the wafer W from above.

In the alignment apparatus according to this exemplary embodiment, the holding stage 1 is larger in size than the wafer W. Therefore, even when the wafer W is transferred to the holding stage 1 in the state that the surface on which the circuit pattern is formed is directed downward, only the annular reinforcing portion r comes into contact with the holding stage 1. Accordingly, the circuit pattern formed on the flat recess c can be prevented from coming into direct contact with the holding stage 1, and therefore is not damaged.

The present invention is not limited to only the exemplary embodiment described above, and may be embodied in accordance with the following modifications.

In the alignment apparatus according to the exemplary embodiment described above, the holding stage 1 and the base 4 are provided separately. Alternatively, only the holding stage 1 made of the transparent material may be employed without use of the base 4.

In the alignment apparatus according to the exemplary embodiment described above, a reflective type photosensor 2 may be disposed below the holding stage 1 to monitor the outer periphery of the wafer W from below through the transparent holding stage 1.

In the alignment apparatus according to the exemplary embodiment described above, the reflective type photosensor 2 may be disposed above the holding stage 1. In this configuration, the holding stage 1 is not necessarily made of a transparent material.

In the alignment apparatus according to the exemplary embodiment described above, the wafer W may be subjected to centering in such a manner that the guide pins 3 opposed to each other reciprocate in parallel with each other so as to be close to and away from each other.

In the alignment apparatus according to the exemplary embodiment described above, the guide pin 3 serving as a guide member has a plane coming into contact with the wafer W. Herein, this plane may be flat so as to simply come into contact with the outer periphery of the wafer W. Alternatively, this plane may be curved, but almost flat. Still alternatively, this plane may be curved in accordance with a curvature of the outer periphery of the wafer W. In the configuration described above, the arcuate guide pin can widely come into contact with the wafer W as compared with a point contact, leading to further reduction of an impact by the contact and a concentrated stress applied by the contact.

In the alignment apparatus according to the exemplary embodiment described above, the wafer W to be subjected to processing may be a reinforced wafer having a configuration that an orientation mark serving as a portion for alignment is formed on an outer periphery.

In the alignment apparatus according to the exemplary embodiment described above, the wafer W placed on the holding stage 1 may be subjected to alignment, based on information (e.g., a coordinate) of a position of the wafer W obtained from information about an image of the wafer W captured by a CCD camera. In this case, the center of the wafer W can be aligned with the center of the holding stage 1 in such a manner that the holding stage 1 is configured to be horizontally movable in two directions which are orthogonal to each other.

In order to perform the alignment based on the notch n, first, the obtained image is subjected to pattern matching to a reference image obtained in advance, so that a deviation amount and a deviation direction of the obtained image from the reference image are obtained. Based on the deviation amount and the deviation direction, the position of the wafer W may be corrected to the position of the reference image.

In order to allow the holding stage 1 to move horizontally, for example, the holding stage 1 is disposed on upper and lower movable tables which move along orthogonal guide rails, respectively. That is, each movable table can reciprocate through a feed-screw type mechanism coupled to a drive device such as a motor.

In the alignment apparatus according to the exemplary embodiment described above, the wafer W to be subjected to processing has the bared circuit pattern. Alternatively, the alignment apparatus may be employed for a wafer having a circuit pattern to which a protective tape is joined.

It will be apparent to those skilled in the art that various modifications and variations can be made in the present invention without departing from the spirit or scope of the invention. Thus, it is intended that the invention cover the modifications and variations of the invention provided they come within the scope of the appended claims and their equivalents.

What is claimed is:

1. An alignment apparatus for a semiconductor wafer including an annular ridge serving as a reinforcing portion, the annular ridge being formed on an outer periphery thereof, a flat recess having a circuit pattern formed thereon, the flat recess being surrounded with the reinforcing portion, and a cutout portion for alignment formed on the reinforcing portion,
the alignment apparatus comprising:
a rotatable holding stage that includes a wafer placement plane which is larger in size than the semiconductor wafer;
an optical sensor that detects the portion for alignment formed on the outer periphery of the semiconductor wafer placed on the holding stage in a state that the side on which the circuit pattern is formed is directed downward;
a driving mechanism that turns the holding stage; and
a control section that performs alignment on the semiconductor wafer, based on the result of detection by the optical sensor.

2. The alignment apparatus according to claim 1, wherein
the holding stage has an outer placement area on which at least the portion for alignment formed on the reinforcing portion lies, the outer placement area being made of a transparent material, and
the optical sensor includes a projector and a photodetector opposed to each other with the transparent area of the holding stage interposed therebetween.

3. The alignment apparatus according to claim 1, further comprising
a guide member that presses the semiconductor wafer placed on the holding stage in a circumferential direction, and aligns a center of the semiconductor wafer with a center of the holding stage.

4. The alignment apparatus according to claim 3, wherein
the guide member is a short column guide pin provided upright.

5. The alignment apparatus according to claim 3, wherein
the guide pin has a curved surface coming into contact with the semiconductor wafer, the curved surface being formed in accordance with a curvature of the semiconductor wafer.

6. The alignment apparatus according to claim 1, further comprising
a horizontal driving mechanism that allows the holding stage to horizontally move on a horizontal plane in a longitudinal direction and a lateral direction, wherein
the control section performs the alignment on the semiconductor wafer, based on information about an image captured by the optical sensor serving as a CCD camera.
